(19) United States
(12) Patent Application Publication
(10) Pub. No.: US 2023/0032827 A1
(43) Pub. Date: Feb. 2, 2023

(54) HOUSING FOR ACCOMMODATING AT LEAST ONE FUEL-CELL STACK

(71) Applicant: Robert Bosch GmbH, Stuttgart (DE)

(72) Inventor: Lutz Schilling, Fellbach (DE)

(21) Appl. No.: 17/786,030

(22) PCT Filed: Nov. 13, 2020
(86) PCT No.: PCT/EP2020/082007

§ 371 Date: Jun. 16, 2022

(30) Foreign Application Priority Data
Dec. 19, 2019 (DE) 10 2019 220 097.4

(51) Int. Cl. H01M 8/2475

(52) U.S. Cl. CPC H01M 8/2475; H01M 2250/20

(57) ABSTRACT

The invention relates to a housing (10) in which at least one fuel-cell stack (20) is accommodated. The fuel-cell stack (20) comprises a number of electrolyte membranes (54) and bipolar plates (34) arranged one above the other. The housing (10) comprises an inner side (12), which is directed towards the at least one fuel-cell stack (20) and on which is formed a ribbing arrangement (14), which increases the surface area of the housing (10), or individual bipolar plates (34) within the at least one fuel-cell stack (20) have a projecting portion (36). The invention also relates to the use of the housing in a fuel cell having at least one fuel-cell stack (20) for driving an electric vehicle.

### BACKGROUND

The invention relates to a housing for accommodating at least one fuel-cell stack, which comprises a number of electrolyte membranes and bipolar plates arranged one above another, having a inner side which faces the at least one fuel-cell stack. Moreover, the invention relates to the use of the housing in a fuel cell having at least one fuel-cell stack for driving an electrically driven vehicle.

Fuel cells are generally operated with gaseous hydrogen (H₂) and are almost always operated as an interconnection of a number of individual cells to form a fuel-cell stack. The individual cells are typically sealed with respect to one another by an elastomer seal. Fuel-cell stacks with up to 500 cells and equally many seals are generally used. In normal operation, it happens that small quantities of H₂ escape via these seals. In the event of damage to one or more of the said seals, larger quantities of gaseous hydrogen may escape. In both case, there is the possibility of an explosive mixture forming. To prevent the accumulation of an explosive mixture, the housing is typically ventilated with ambient air.

DE 100 01 717 V1 relates to a fuel-cell system. This comprises at least one fuel-cell unit, which is housed in a fuel-cell box and/or is associated with a cathode gas or cold-start gas supply line or a cathode off-gas or anode off-gas return line. The fuel-cell system is equipped with at least one Coanda flow amplifier in order to amplify the airflow for the ventilation of a fuel-cell box, a cathode gas flow or a cold-start gas flow, a returned cathode off-gas flow or a returned anode off-gas flow and/or the system is equipped with a ventilation means for a housing outside the fuel-cell box, in which components of the fuel-cell system are combined, wherein the ventilation means have a Coanda flow amplifier.

DE 100 31 238 A1 relates to a fuel-cell system and a method for the operation thereof. At least one fuel-cell unit incorporated in a fuel-cell box is provided, wherein box ventilation means are provided, which have a flushing-media supply line leading into the fuel-cell box and a flushing-media outlet line leading out of the fuel-cell box. An explosion-protected fan is located in the flushing-media supply line and/or in the flushing-media outlet line and/or ventilation means for a housing outside the fuel-cell box are provided, which have a flushing-media supply line leading into the housing and a flushing-media outlet line leading out of the housing. These are combined in the housing of the fuel-cell system, wherein the ventilation means comprise an explosion-protected fan.

In the event of an explosion of a closed container, for example the housing, which surrounds a fuel cell, maximum explosion pressures of up to 8.5 barg may occur with a stoichiometric Hz/air mixture. In applications which are currently used in practice, a fuel-cell stack housing is designed to be rectangular, wherein the surface of the housing and other installations, for example sensor valves and pumps, contribute to an increase in the surface area of the housing.

In view of the fact that an expected maximally occurring explosion pressure is 8.5 barg, a housing for accommodating a fuel cell is configured for a pressure of 8.5 barg according to current practice. This results in a relatively high material usage and consequently a relatively high weight. Moreover, pressure-relieving structures, in particular rupture disks, are included.

### SUMMARY

According to the invention, a housing for accommodating at least one fuel-cell stack is proposed, which comprises a number of electrolyte membranes and bipolar plates arranged one above another, having an inner side which faces the at least one fuel-cell stack. On the inner side of the housing, a ribbing is formed, which increases the surface area of said housing, or individual bipolar plates within the fuel-cell stack each have a projecting portion.

A greatly increased surface area of the housing can be achieved by the solution according to the invention. In particular, the increase in the surface area on the inner side of the housing can be realized by providing ribs or nubs on the inner side of the housing.

In a further configuration of the solution proposed according to the invention, the ribbing on the inner side of the housing extends in the longitudinal direction, starting from a top side, in the direction of a bottom side of the housing. Alternatively, there is the possibility of the ribbing on the inner side of the housing extending in the transverse direction, i.e. parallel to the top side of the housing, for example. Moreover, according to a further embodiment variant, it is possible that the ribbing on the inner side of the housing extends in the diagonal direction from the top side of the housing to its bottom side.

Common to all of the said embodiment variants of the ribbing is that, by providing this ribbing on the inner side of the housing, the surface area of this housing is dramatically increased, which advantageously results in a reduction in the maximally occurring explosion pressure.

In a development of the solution proposed according to the invention, on the inner side of the housing and the outer side of the at least one fuel-cell stack, a channel is formed, which enables a ventilation flow. This channel extends between the housing and the fuel-cell stack and enables hydrogen which has possibly escaped from individual fuel cells as a result of leakage to be discharged via ambient air. The channel can be formed for example by gaps, which are formed due to the length of individual ribs of the ribbing on the inner side of the housing in the direction of the at least one fuel-cell stack. Depending on the length of the individual ribs, clearances which form the channel serving for the ventilation flow remain between the outer side of the at least one fuel-cell stack and the inner side of the housing.

In a development of the solution proposed according to the invention, an insulation layer can extend between the inner side of the housing and the outer side of the at least one fuel-cell stack.

In the solution proposed according to the invention, when realizing the channel for the ventilation flow to pass through, there is the possibility of creating this channel via openings in the individual ribs of the ribbing so that the ventilation flow passes through this channel from individual rib to individual rib of the ribbing, wherein individual chambers can be formed between the individual ribs.

In a development of the solution proposed according to the invention, the at least one fuel-cell stack is composed of bipolar plates and electrolyte membranes, wherein individual bipolar plates can each have a projecting portion which protrudes towards the inner side of the housing without contacting it.

In the solution proposed according to the invention, each second to tenth bipolar plate within the at least one fuel-cell stack can have the said projecting portion. In a kinematic reversal, the ventilation channel between the inner side of the housing and the outer side of the fuel-cell stack is therefore formed not by a ribbing extending on the inner side of the housing, but by individual projecting portions which extend from each second to tenth bipolar plate in the direction of the inner side of the housing without contacting this housing or the insulation layer provided there. It is thus ensured that a gap or clearance always remains, through which the ventilation flow can pass.

In the solution proposed according to the invention, the bipolar plates can be formed with a greater material thickness within the projecting portion so as to counteract the formation of short-circuits caused by bipolar plates bending.

Moreover, the invention relates to the use of the housing in a fuel cell having at least one fuel-cell stack for driving an electrically driven vehicle.

As a result of the solution proposed according to the invention, the maximally occurring explosion pressure within a housing for a fuel cell having at least one fuel-cell stack can be significantly reduced. In an ideal case, with an ideally large surface area, the explosion can be extinguished and converted into simple combustion with an even lower pressure level as a result of the solution proposed according to the invention. As a result, there is in turn the possibility of using a less pressure-tight housing, thereby enabling reductions in weight and material.

As a result of the reduced pressure level, it is moreover possible to provide a closed housing without a device for ventilation, for the input and output of ventilators, H2 sensors and explosion-protected ventilators. The complexity of the apparatus, disregarding the ventilation flow passing through the fuel cell, which is provided in any case, is thus significantly reduced.

As a result of the solution proposed according to the invention, an inner side of the housing can either be provided by providing ribbing, whether extending in the transverse direction, longitudinal direction or in the diagonal direction, or, on the other hand, there is the possibility of providing individual bipolar plates within the stack structure of the at least one fuel-cell stack with a projecting portion so that the surface area is significantly increased as a result of these projecting portions. The larger the possible size of the surface area of the housing on its inner side or the surface area on the outer side of the at least one fuel-cell stack, the lower the explosion pressure which can be reached.

To prevent electrical contact between individual bipolar plates of the at least one fuel-cell stack and the inner side of the housing, insulation layers can be provided. A channel, through which the ventilation flow circulates, can be formed either by openings in individual ribs of the ribbing or it can be formed by individual ribs of the ribbing having a shorter design, so that a gap through which the ventilation flow can pass remains between the end of the respective individual rib and the outer side of the fuel-cell stack opposite this end.

As a result of the solution proposed according to the invention, an explosion pressure level of 5.4 barg to 2.8 barg can be achieved, for example, which contributes to significantly more favorable, i.e. simpler and more cost-effective, manufacture of a housing for accommodating at least one fuel-cell stack for a fuel cell.

As a result of the ribbing, which is provided on the inner side of the housing, the housing can be reinforced, which advantageously enables the housing to be used as a supporting structure for the entire fuel-cell system. The gas volume is reduced by the ribbing provided on the inner side, which additionally contributes to the reduction in the explosion pressure. If the bipolar plates within the stack structure of the fuel cell, which are alternatively formed with a projecting portion, are not in electrical contact with the housing and are designed in a stable manner, for example with a greater material thickness, forces of the fuel-cell stack can thus be transmitted to the housing. Horizontally arranged fuel-cell stacks with a plurality of individual cells have a tendency to bend and are sensitive to shocks which occur during operation of a vehicle. These place an uneven strain on the seals of the individual cells so that leakages may occur.

As a result of the solution proposed according to the invention, these leakages can be accommodated to a large extent through the removal of an ignitable Hz/air mixture.

### BRIEF DESCRIPTIONS OF THE DRAWINGS

Embodiments of the invention are explained in more detail with reference to the drawings and the description below.

In the drawings,

FIG. 1 shows an inner side of a housing with ribbing extending in the longitudinal direction;

FIG. 2 shows a combination of the fuel-cell stack and the housing, wherein a longitudinal ribbing is formed on the inner side of the housing;

FIG. 3 shows a view from above of a fuel-cell stack which is provided with a ribbing extending into the plane of the drawing, i.e. in the longitudinal direction, in a housing;

FIG. 4 shows an embodiment variant of a fuel-cell stack in which individual bipolar plates are formed with a projecting portion; and

FIG. 5 shows an enlarged representation of a view of a fuel-cell stack with individual bipolar plates which are provided with a projecting portion and protrude towards the inner side of the housing.

### DETAILED DESCRIPTION

In the description below of embodiments of the invention, the same or similar elements are denoted by the same reference signs, wherein a repeated description of these elements is omitted in individual cases. The figures are merely a schematic representation of the subject matter of the invention.

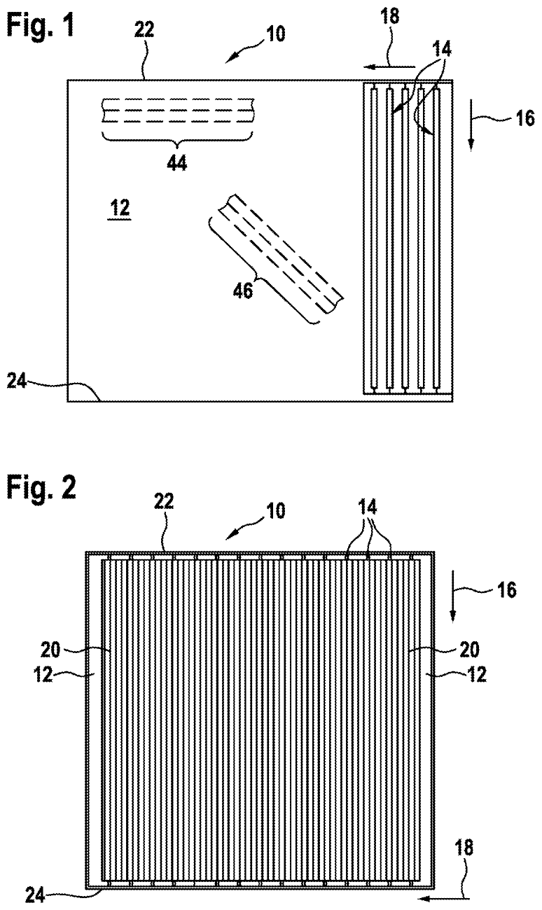

FIG. 1 shows a housing 10, on the inner side 12 of which a ribbing 14 is formed. The illustration according to FIG. 1 reveals that the ribbing 14, having a number of individual ribs 33 extending in the longitudinal direction 16, extends on the inner side 12 of the housing 10. The ribbing 14 extends on the inner side 12 of the housing 10 from the top side 22 to its bottom side 24.

FIG. 2 shows a combination of at least one fuel-cell stack 20, which is accommodated in the housing 10 having a ribbing 14. FIG. 2 shows that, on the inner side 12 of the housing 10, individual ribs 33 of the ribbing 14 extend at an even spacing from one another, in particular in the longitudinal direction 16. Alternatively, there is the possibility that the ribbing 14 may extend not in the longitudinal direction 48, but also perpendicularly thereto in the transverse direction 44 or in a diagonal direction 46, with an associated corresponding elongation on the inner side 12 of the housing 10, as illustrated in FIG. 1.

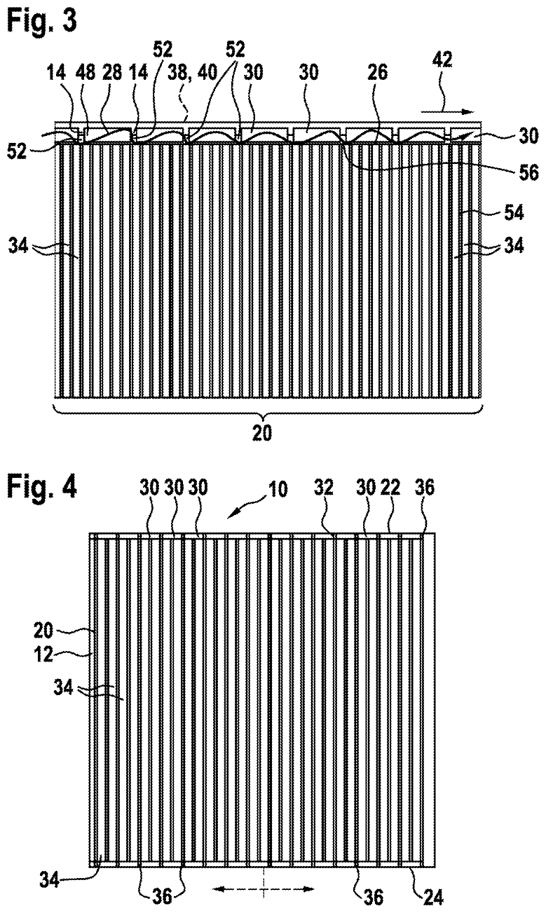

FIG. 3 shows a plan view of a fuel-cell stack 20, which is accommodated in a housing 10. To achieve an increase 40 in its inner surface area 38, the ribbing 14 is formed on the inner side 12 of the housing 10. This ribbing extends in the longitudinal direction 16, i.e. the longitudinal direction 48 extending perpendicularly into the plane of the drawing according to FIG. 3. Corresponding to the longitudinal extent of the individual ribs 33 of the ribbing 14 in the direction of the at least one fuel-cell stack 20, gaps 26 through which a ventilation flow 28 can pass remain between the outer side of the at least one fuel-cell stack 20 comprising a plurality of bipolar plates 34 and electrolyte membranes 54, which are accommodated one above another. The ventilation flow 28 is in particular ambient air. The ventilation flow 28 has the task of carrying possibly occurring leakages of gaseous hydrogen out of the housing 10 to prevent the formation of an explosive mixture. The illustration according to FIG. 3 reveals that chambers 30 are formed between the individual ribs 33 of the ribbing 14, which extends in the longitudinal direction 16 here. The ventilation flow 28, which flows in the ventilation direction 42, flows through these chambers 30 and gaseous hydrogen which has possibly collected there is transported out of the individual chambers 30, which are part of a ventilation channel 56, so that the formation of an explosive mixture does not occur. The ventilation channel 56, which connects the individual chambers 30 to one another, can be formed by individual openings 52 in the individual ribs 33 of the ribbing 14 on the inner side 12 of the housing 10. The ventilation flow 28, i.e. the ambient air, flows through the ventilation channel 56 in the ventilation direction 42 and carries away any leakage of escaped hydrogen which may be present.

FIG. 3 furthermore reveals that the at least one fuel-cell stack 20 comprises a number of bipolar plates 34 and electrolyte membranes 54. These are arranged such that they are stacked one above another in the at least one fuel-cell stack 20. Sealing elements (not illustrated in more detail here) are provided between the individual bipolar plates 34 and electrolyte membranes 54.

It has been shown that there is an empirical connection between an actual surface area of a housing and an enclosed gas volume. A maximum pressure is calculated as

$${p}_{m a x} = 0.146 O / V + 8.32 . \\ with {p}_{m a x} = maximum explosion pressure ( barg ) = total inner surface \\ area ( {m}^{2} ) and V = enclosed gas volume ( {m}^{3} ) .$$

As a reference for one configuration, a fuel-cell stack 20 and a housing 10 having the following specifications can be used: stack having 400 cells and end plates, height×width×depth=500×500×150 mm³, housing 10 around the fuel-cell stack 20, height×width×depth=520×520×170 mm³, surface area of the fuel-cell stack 20 (rounded)=0.8 m², surface area of the housing 10 (internally rounded)=0.9 m² and enclosed gas volume (rounded)=0.85 m³. Taking into account the above-mentioned values, a maximum explosion pressure of 5.4 barg is generated. It is therefore necessary to configure a housing 10 for an explosion pressure of at least 5.4 barg, which would result in a high material usage and a correspondingly high weight.

If a housing 10 having a ribbing 14 proposed according to the invention is now considered, the resulting values are as follows: fuel-cell stack having 400 cells and end plates, height×width×depth=500×500×150 mm³, housing 10 around the fuel-cell stack 20, height×width×depth=520×520×170 mm³, ribbing 14 in the transverse direction with spacing×height×thickness=10×10×1 mm³, surface area of the stack 20 (rounded)=0.8 m², surface area of the housing 10 plus ribbing 14 on the inside (rounded)=2.2 m², enclosed gas volume minus ribbing 14 (rounded)=0.79 m³.

With the above-mentioned specifications, the result is a reduced maximum explosion pressure of only 2.8 barg. This constitutes significant improvement potential, since the housing 10 can now have a significantly lighter construction, which not only results in a significant reduction in the operating weight but also in a significant reduction in the costs of the material used.

The illustration according to FIG. 4 reveals an embodiment variant of a fuel-cell stack 20 which is composed of a number of bipolar plates 34 and electrolyte membranes 54. FIG. 4 shows that individual bipolar plates 34 of the bipolar plates layered one above another have a projecting portion 36. As a result of kinematic reversal, compared to FIG. 3, a corresponding projecting portion 36 on each second to tenth bipolar plate 34 within the fuel-cell stack 20 can result in the formation of the ventilation channel 56 (c.f. FIG. 3) between the inner side 12 of the housing 10 and the outer side of the fuel-cell stack 20 simply by means of the projecting portions 36. The individual projecting portions 36 of each second to tenth bipolar plate 34 can be provided with openings 52, for example, so that the ventilation channel 56 for the ventilation flow 28, which flows in the ventilation direction 42, can be formed between the inner side 12 of the housing 10 and the outer side of the at least one fuel-cell stack 20. The ventilation channel 56 can be formed in that, between the ends of the individual projecting portions 36 of the bipolar plates 34 and the inner side 12 of the housing 10, gaps 26 remain, via which individual chambers 30, through which the ventilation flow 28 passes, are formed between the projecting portions 36 of the bipolar plates 34. It is thus ensured that the passage of the ventilation flow 28 is also ensured in this embodiment variant of the solution proposed according to the invention and gaseous hydrogen which has possibly collected in the chambers 30 can be transported swiftly away without the generation of an explosive Hz/air mixture occurring.

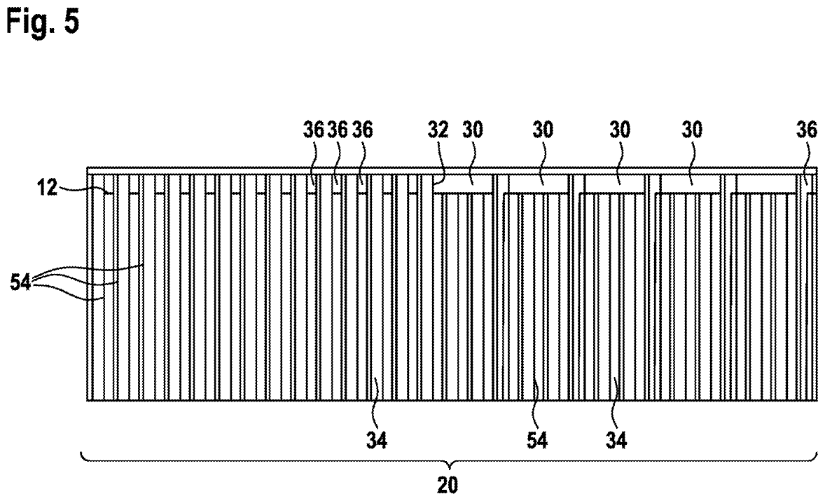

FIG. 5 shows, in an enlarged illustration, the bipolar plates 34, each provided with a projecting portion 36, within the at least one fuel-cell stack 20. Depending on the configuration of the at least one fuel-cell stack 20, each second to tenth bipolar plate 34 can be provided with the projecting portions 36 to result in the formation of individual chambers 30. To prevent electrical short-circuits, there is the possibility of designing the projecting portions 36 with a greater material thickness so that a bending thereof and the occurrence of short-circuits with the adjacent bipolar plate 34 can be prevented. There is furthermore the possibility of including at least one insulating layer 50 in the housing 10, between the inner side 12 of the housing 10 on the one hand and the ends of the projecting portions 36, or the ends of the bipolar plates 34, in order to prevent electrical short-circuits. The plan view according to FIG. 5 furthermore reveals that electrolyte membranes 54 are accommodated in each case between the individual bipolar plates 34 within the at least one fuel-cell stack 20. The chambers 30 illustrated in FIG. 5, which are delimited by individual projecting portions 36 of bipolar plates 34 formed with an overlength, also comprise gaps 26 (c.f. illustration according to FIG. 3), through which the ventilation flow 28 can pass in the ventilation direction 42 and which can therefore transport gaseous hydrogen out of the housing 10 in which at least one fuel-cell stack 20 is arranged.

As further elements which increase the surface area, corrugated sheet parts, gauze, metal fabric or honeycomb panels, for example, can also be incorporated in the free gas volume, whereby the surface area can be significantly increased. At the same time, the free gas volume which is still present is significantly reduced. However, the reinforcing effect of the housing 10 is omitted in this variant and can be applied to the embodiments described above as an additional measure. There is furthermore the possibility of applying a bonded honeycomb structure to the inner side 12 of the housing, for example, whereby the housing 10 can be reinforced to a considerable extent.

The invention is not restricted to the exemplary embodiments descried here and the aspects highlighted therein. Instead, within the scope specified by the claims, a plurality of modifications is also possible within the scope of the activity of a person skilled in the art.

1. A housing (10) for accommodating at least one fuel-cell stack (20), which comprises a number of electrolyte membranes (54) and bipolar plates (34) arranged one above another, having an inner side (12) which faces the at least one fuel-cell stack (20), wherein on the inner side (12) of the housing (10), a ribbing (14) is formed, which increases the surface area of [[this]]the housing, or individual bipolar plates (34) within the at least one fuel-cell stack (20) have a projecting portion (36).

2. The housing (10) as claimed in claim 1, wherein the ribbing (14) on the inner side (12) of the housing (10) extends in a longitudinal direction (16) from a top side (22) to a bottom side (24) of the housing (10).

3. The housing (10) as claimed in claim 1, wherein the ribbing (14) on the inner side (12) of the housing (10) extends in a transverse direction (44) with respect to the top side (22) of the housing (10).

4. The housing (10) as claimed in claim 1, wherein the ribbing (14) extends from the inner side (12) of the housing (10) in a diagonal direction (46) from the top side (22) of the housing (10) to its bottom side (24).

5. The housing (10) as claimed in claim 1, wherein between the inner side (12) of the housing (10) and the outer side of the at least one fuel-cell stack (20), a ventilation channel (56) is formed, which enables a ventilation flow (28).

6. The housing (10) as claimed in claim 5, wherein the ventilation channel (56) is formed by gaps (26), which are formed due to the length (32) of individual ribs (33) of the ribbing (14) in a direction of the at least one fuel-cell stack (20).

7. The housing (10) as claimed in claim 1, wherein an insulation layer (50) extends between the inner side (12) of the housing (10) and the outer side of the at least one fuel-cell stack (20).

8. The housing (10) as claimed in claim 5, wherein the ventilation channel (56) is formed by openings (52) in individual ribs (33) of the ribbing (14).

9. The housing (10) as claimed in claim 1, wherein the at least one fuel-cell stack (20) of bipolar plates (34) and electrolyte membranes (54) comprises bipolar plates (34), which each have a projecting portion (36) and protrude towards the inner side (12) of the housing (10) without contacting the inner side (12).

10. The housing (10) as claimed in claim 9, wherein each second to tenth bipolar plate (34) in the at least one fuel-cell stack (20) has the projecting portion (36).

11. The housing (10) as claimed in claim 9, wherein projecting portions (36) on the bipolar plates (34) are formed with a greater material thickness than [[the]]a material thickness of the bipolar plates (34).

12. The use of the housing (10) as claimed in claim 1 in a fuel cell having at least one fuel-cell stack (20) for driving an electrically driven vehicle.
